(19) United States
(12) Patent Application Publication
(10) Pub. No.: US 2010/0066265 A1
(43) Pub. Date: Mar. 18, 2010

(54) DISCHARGE LAMP LIGHTING DEVICE AND PROJECTOR

(76) Inventor: Hiroshi Itoh, Osaka (JP)

Correspondence Address: BIRCH STEWART KOLASCH & BIRCH, PO BOX 747, FALLS CHURCH, VA, 22040-0747, US

(21) Appl. No.: 12/516,753

(22) PCT Filed: Oct. 30, 2007
(86) PCT No.: PCT/JP2007/071129

§ 371 Date: May 28, 2009

(30) Foreign Application Priority Data
Nov. 29, 2006 (JP) 2006-321653

(51) Int. Cl. H05B 41/36

(52) U.S. Cl. 315/291

(57) ABSTRACT

A thyristor and an auxiliary resistor having one end connected to a gate of the thyristor are connected in parallel with a resistor connected in series with a lamp. A resistance value of internal equivalent resistance of the thyristor in an on-state is smaller than a resistance value of the resistor. The resistor absorbs a rush current at a lighting time. Then, a current flows between an anode and a cathode of the thyristor.

(US only) This application is the national phase under 35 U.S.C. §371 of PCT International Application No. PCT/JP2007/71129 which has an International filing date of Oct. 30, 2007 and designated the United States of America.

### BACKGROUND

1. Technical Field

The present invention relates to a discharge lamp lighting device which lights a discharge lamp, and more particularly relates to a discharge lamp lighting device which reduces a rush current at start-up of lighting of the discharge lamp, and a projector provided with the discharge lamp lighting device.

2. Description of Related Art

A short arc type metal halide lamp or a high-pressure mercury lamp is used for a liquid crystal projector, an overhead projector, or general illumination, or the like. In order to light the metal halide lamp, a discharge lamp lighting device is used. The discharge lamp lighting device used for the projector etc. generates high voltage of about ten kV by an ignitor at start-up, and applies the high voltage to the discharge lamp, thereby causing dielectric breakdown. In this case, there is a problem that a rush current of high current flows through the discharge lamp at a moment of dielectric breakdown, thereby giving damage to an electrode of the discharge lamp. A charge source of the rush current is a capacitor which is inserted in parallel with the lamp in order to suppress a switching ripple current which flows through the lamp. A path of the rush current is a path which extends from the capacitor to the lamp and returns to the capacitor. Recently, there is a case where a choke coil etc. is not inserted in the path for reduction of a size of the discharge lamp lighting device. In this case, impedance of the path decreases and a rush current increases.

In order to solve this problem, conventionally a lighting device is proposed in which a plurality of capacitors having different capacitance are provided, and the capacitors are switched using a FET (Field-Effect Transistor) at start-up of lighting and after an arc discharge shift (for example, refer to Japanese Patent Application Laid-Open No. 2003-100487 or Japanese Patent Application Laid-Open No. 2005-203197). Also, a power supply apparatus is known in which a resistor for limiting a current is connected in series with the discharge lamp, a switch is turned on at start-up of lighting to connect the discharge lamp with the resistor, and after stabilization the switch is turned off to shut off connection with the resistor (for example, refer to Japanese Patent Application Laid-Open No. 2006-49061). Moreover, a method is known in which the capacitor, resistor, or switch etc. is switched based on a lamp current or lamp voltage which is detected, in addition to switching by a timer etc. (for example, refer to Japanese Patent Application Laid-Open No. 2000-182796).

### SUMMARY

However, the method disclosed in Japanese Patent Application Laid-Open No. 2003-100487 or Japanese Patent Application Laid-Open No. 2005-203197 in which the capacitors are switched has a problem that the FET generates heat. The respective lighting devices disclosed in Japanese Patent Application Laid-Open No. 2003-100487, Japanese Patent Application Laid-Open No. 2005-203197, Japanese Patent Application Laid-Open No. 2006-49061 and Japanese Patent Application Laid-Open No. 2000-182796 which use a timer etc. and adopt switching control have a problem that control by several μs unit cannot be realized, and a desired operation cannot follow the behavior of the lamp when an unexpected going-out of the lamp occurs, or the like.

The present invention has been made with the aim of solving the above problem, and it is an object of the present invention to provide a discharge lamp lighting device which reduce a rush current, reduce power consumption, has a high response speed, and follows a change of the lamp sufficiently, by using a thyristor and an auxiliary resistor which are connected in parallel with a resistor connected in series with a discharge lamp, and a projector provided with the discharge lamp lighting device.

Moreover, another object of the present invention is provide a discharge lamp lighting device capable of further reducing power consumption without reducing the response speed, by turning on a switching element connected in parallel after breakover of the thyristor, and a projector provided with the discharge lamp lighting device.

A discharge lamp lighting device according to the present invention is a discharge lamp lighting device which lights a discharge lamp, characterized by comprising: a resistor connected in series with said discharge lamp; a thyristor connected in parallel with said resistor; and an auxiliary resistor connected between an anode and a gate of said thyristor.

A discharge lamp lighting device according to the present invention is characterized in that said auxiliary resistor controls said thyristor from off to on, by passing a gate current through said thyristor with the use of voltage generated across said resistor as a power source.

A discharge lamp lighting device according to the present invention is characterized in that that said thyristor in an on-state shifts from on to off according to a state of a current which flows through said discharge lamp.

A discharge lamp lighting device according to the present invention is characterized in that said resistor, said thyristor and said auxiliary resistor are in floating states with respect to a ground.

A discharge lamp lighting device according to the present invention is characterized by further comprising: a switching element connected in parallel with said resistor, said thyristor, and said auxiliary resistor; and a switching controller which switches said switching element from off to on after breakover of said thyristor.

A discharge lamp lighting device according to the present invention is characterized in that a resistance value of internal equivalent resistance between the anode and a cathode of said thyristor in an on-state is smaller than a resistance value of said resistor.

A discharge lamp lighting device according to the present invention is characterized in that a resistance value of on-resistance of said switching element in an on-state is smaller than a resistance value of internal equivalent resistance between the anode and the cathode of said thyristor in an on-state.

A projector according to the present invention is a projector, characterized by comprising one of the above-mentioned discharge lamp lighting devices.

In the present invention, the discharge lamp lighting device is constituted with the resistor connected in series with the discharge lamp, the thyristor, and the auxiliary resistor connected between the anode and gate of the thyristor.

A resistance value of internal equivalent resistance between the anode and cathode of the thyristor in an on-state is smaller than a resistance value of the resistor. A rush current after dielectric breakdown flows through the resistor since the thyristor is in an off-state. Then, the current flows through the gate of the thyristor via the auxiliary resistor with the rise of a pressure value of the resistor. Breakover of the thyristor occurs with the rise of a gate current, a current flows from the anode to the cathode of the thyristor and does not flow through the resistor and auxiliary resistor of a high resistance value.

In the present invention, the switching element is connected in parallel with the resistor and the thyristor. And the switching controller switches the switching element from off to on after elapse of a predetermined period of time after breakover of the thyristor. In this case, a resistance value of on-resistance of the switching element in an on-state is smaller than a resistance value of internal equivalent resistance between the anode and cathode of the thyristor in an on-state. Thereby, after the discharge lamp operates stably, a current which has flowed through the thyristor flows through the switching element connected in parallel.

According to the present invention, since the thyristor is connected in parallel with the resistor connected in series with the discharge lamp, a rush current after dielectric breakdown flows through the resistor since the thyristor is in an off-state. Thereby, a rush current can be absorbed by the resistor effectively and an improvement of the service life of the discharge lamp can be attained. Moreover, a current flows through a gate of the thyristor via the auxiliary resistor with the rise of a pressure value across the resistor. And breakover of the thyristor occurs with the rise of a gate current, a current flows from the anode to the cathode of the thyristor and does not flow through the resistor and auxiliary resistor of a high resistance value. As a result, the discharge lamp lighting device is constituted such that a flow of current can be switched in order of the resistor and the thyristor with a simple constitution, without using a switching element, a timer, etc. which require extremal control, thereby reducing a size thereof and obtaining a higher speed response. Moreover, the resistance value of internal equivalent resistance of the thyristor in an on-state is small enough as compared with the resistance value of the resistor, thereby reducing power consumption of the thyristor.

According to the present invention, the switching controller switches the switching element from off to on after elapse of a predetermined period of time after breakover of the thyristor. In this case, the resistance value of on-resistance of the switching element is smaller than the resistance value of internal equivalent resistance of the thyristor in an on-state. Thereby, after the discharge lamp operates stably, a current which has flowed through the thyristor flows through the switching element connected in parallel. Therefore, the present invention has an outstanding effect such as reducing more power consumption after the stable operation, without sacrificing a speed of response.

The above and further objects and features will more fully be apparent from the following detailed description with accompanying drawings.

### BRIEF DESCRIPTION OF THE DRAWINGS

FIG. 1 is a circuit diagram showing circuitry of a discharge lamp lighting device.

FIGS. 2A through 2D are graphs showing temporal variation of voltage and current of respective parts of the discharge lamp lighting device.

FIG. 3 is a circuit diagram showing circuitry of a lighting device according to Embodiment 2.

FIG. 4 is a block diagram showing a hardware configuration of a projector.

FIG. 5 is a circuit diagram showing circuitry of a discharge lamp lighting device according to Embodiment 4.

### DETAILED DESCRIPTION

### Embodiment 1

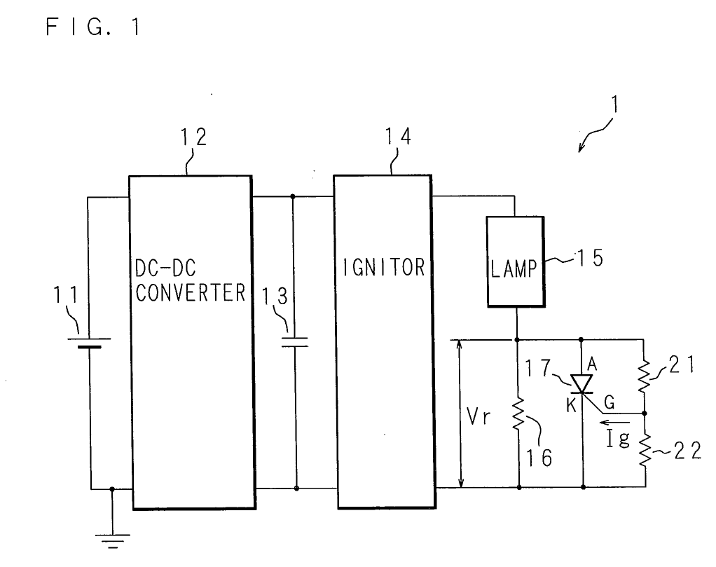

The following description will explain Embodiments of the present invention, based on the drawings. FIG. 1 is a circuit diagram showing circuitry of a discharge lamp lighting device 1. In FIG. 1, 1 denotes the discharge lamp lighting device (hereinafter, lighting device 1), and is constructed including a direct-current power supply 11, a DC-DC converter 12, a capacitor 13, an ignitor 14, a discharge lamp (hereinafter, lamp) 15, a resistor 16, a silicon controlled rectifier (thyristor) 17, an auxiliary resistor 21, and a protective resistor 22. The DC-DC converter 12 is connected to the direct-current power supply 11. The capacitor 13 is connected in parallel with the latter part thereof, and the ignitor 14 is connected to the latter part thereof. The DC-DC converter 12 raises or lowers voltage from the direct-current power supply 11, and controls lighting so that power to be supplied to the lamp 15 becomes a rated value of the lamp 15 by turning on/off a not-shown switching element provided therein. The capacitor 13 is a component for smoothing and reducing a switching ripple current which flows through the lamp 15 and has a capacity of 1 μF (microfarad) to 10 μF, for example. Note that since circuitry of the DC-DC converter 12 and circuitry of the ignitor 14 are known, detailed explanation thereof is omitted. The direct-current power supply 11 has a negative electrode which is grounded.

For actuating the lamp 15, converted voltage is generated at both ends of the capacitor 13 by the DC-DC converter 12, and the ignitor 14 operates in response to the voltage, and applies high voltage of several kV through tens of kV to the lamp 15. In the lamp 15, dielectric breakdown is caused by the high voltage, and a current begins to flow. At a moment when the dielectric breakdown occurs, a rush current flows through the lamp 15 in an instant (several microseconds). A source of a charge of the rush current is the capacitor 13, and the charge is proportional to the capacity of the capacitor 13 and voltage applied to both ends of the capacitor 13 before the dielectric breakdown. The rush current returns from the capacitor 13 via the ignitor 14 and lamp 15 to a low potential side of the capacitor 13. The rush current increases when the impedance of the path is low. For example, when the capacitor 13 has a capacity of 3 μF, applied voltage is 100V, and impedance is low because no choke coil etc. is inserted in the path through which a rush current flows, a current at its peak 100 A flows for a period of 6 μs (microsecond). When 100V is applied to 3 μF, a charge to be stored is 300 μq (microcoulomb) (=300 μF×100V), and when considering a current of 100 A which flows for 6 μs as a triangular wave and integrating a current waveform, about 300 μq (=6 μs×100 A/2) is obtained, and they coincide with each other. An initial lighting state of the lamp 15 after dielectric breakdown is a mode called glow discharge. When sufficient power is supplied to the lamp 15, the glow discharge is shifted to initial arc discharge. During the initial arc discharge, the lamp 15 generates heat, and lamp voltage increases. And eventually, the mode of the lamp 15 is shifted to steady arc discharge, and is lighted in the stabilized state.

The resistor 16 is connected in series with the latter part of the lamp 15, i.e., a cathode side of an electrode of the lamp 15. The thyristor 17, the auxiliary resistor 21 and the protective resistor 22 are connected in parallel with the resistor 16. The auxiliary resistor 21 is connected in series with the protective resistor 22, and the auxiliary resistor 21 has one end connected to a gate of the thyristor 17 and the other end connected to an anode of the thyristor 17. The protective resistor 22 has one end connected to the gate of the thyristor 17 and the other end connected to a cathode of the thyristor 17.

In the present embodiment, as an example, a resistance value of the resistor 16 is set to 10Ω, a resistance value of the auxiliary resistor 21 is set to 820Ω, and a resistance value of the protective resistor 22 is set to 1 kΩ. However, they are not restricted to these, and proper values thereof may be adopted according to rated voltage, specifications of the lamp 15, or the like. A resistance value of internal equivalent resistance between the anode and the cathode when the thyristor 17 is in an on-state is a value smaller enough than a resistance value of the resistor 16. For example, when a current of 2 A is flowing with a voltage drop of 0.8V, the resistance value of internal equivalent resistance is 0.4Ω. Note that hereinafter, voltage across the resistor 16 is represented by Vr, and a gate current of the thyristor 17 is represented by Ig.

In the circuit in FIG. 1, since a gate current Ig is zero, and a current between the anode and the cathode of the thyristor 17 is also zero at a time when dielectric breakdown occurs on the lamp 15 with high voltage generated by the ignitor 14, the thyristor 17 is in an off-state. A resistance value between the anode and the cathode at this time is equivalent to mega-Ω. Before and after dielectric breakdown occurs, a current which flows through the lamp 15 returns to the ignitor 14 and DC-DC converter 12 via the resistor 16. In impedance of a path of a rush current, a resistance value of the resistor 16 is dominant and the rush current is absorbed by the resistor 16. When a peak value of rush current, in a case where a resistance value of the resistor 16 is zeroΩ, is 100 A, the peak value thereof can be suppressed to be equal to or smaller than 10 A, by controlling a resistance value of the resistor 16 to be 10Ω. Thereafter, a state of the lamp 15 is shifted to glow discharge and initial arc discharge. A lamp current also changes according to this shift. For example, during the glow discharge period the lamp current is 0.5 A. During the initial arc discharge period, since equivalent resistance of the lamp 15 is equivalent to negative resistance (a resistance value is minus) and a lamp current flows infinitely without limitation, the current limiting function of the DC-DC converter 12 operates so that a lamp current is restricted to be 2 A, for example. Therefore, with the assumption that the thyristor 17 remains in an off-state, both of the above-mentioned currents of 0.5 A and 2 A flow through the resistor 16. As a result, a drop in voltage Vr across the resistor 16 occurs. When a resistance value is 10Ω, the voltage becomes 5V during glow discharge and becomes 20V during initial arc discharge. A current which flows through the auxiliary resistor 21 changes with a change of the potential difference from 5V to 20V. A current value is set based on the voltage Vr and a resistance value of the auxiliary resistor 21. That is, when a lamp current increases, the voltage Vr also increases and a gate current Ig also increases. And in a process of increase in a gate current Ig and the voltage Vak between the anode and the cathode, conditions for the thyristor 17 to generate breakover are fulfilled, and the thyristor 17 is in an on-state. The conditions for breakover of the thyristor 17 are determined at an operating point which is set according to the voltage Vak between the anode and the cathode and the gate current Ig. After breakover, since internal equivalent resistance at a time when the thyristor 17 is in an on-state is small enough as compared with a resistance value of the resistor 16, it is possible to reduce power consumption because almost no current flows through the resistor 16.

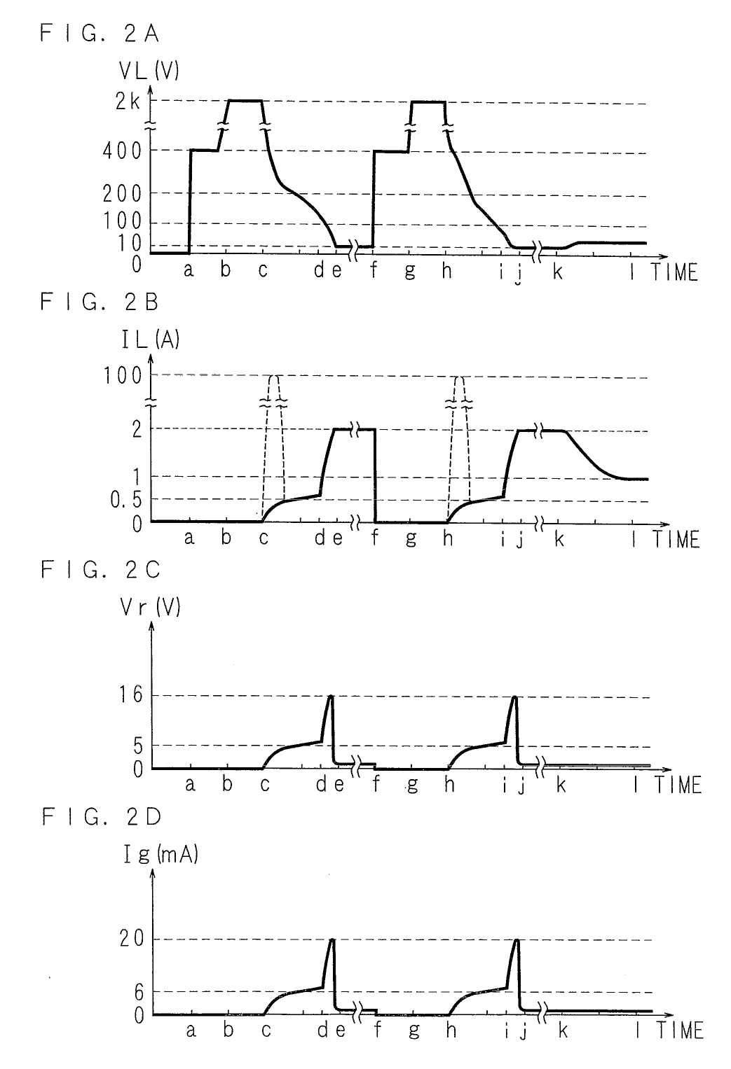

Next, the detailed circuit operation from start-up of the lighting device 1 to attainment of a steady operation time will be explained. Note that hereinafter, an example will be explained in which the lamp 15 goes out once because of an unstable operation mainly due to a large amount of enclosed mercury, when shifting from the initial arc discharge of the lamp 15 to rated arc discharge thereof. FIGS. 2A through 2D are graphs showing temporal variation of voltage and current of respective parts. FIG. 2A shows temporal variation of lamp voltage VL applied to the lamp 15, a vertical axis indicates voltage (a unit is V), and a horizontal axis indicates time. FIG. 2B shows temporal variation of a lamp current IL which flows through the lamp 15, a vertical axis indicates a current (a unit is A), and a horizontal axis indicates time. FIG. 2C shows temporal variation of voltage Vr across the resistor 16, a vertical axis indicates voltage (a unit is V), and a horizontal axis indicates time. FIG. 2D shows temporal variation of gate current Ig of the thyristor 17, a vertical axis indicates current (a unit is μA), and a horizontal axis indicates time.

The horizontal axes of FIGS. 2A through 2D are divided by times a-l. Respectively, a is a start-up time of the lighting device 1, b is an activation time of the ignitor 14, c is a time when dielectric-breakdown of the lamp 15 occurs, c-d is a glow discharge period, d-e is a shift period from glow discharge to initial arc discharge (in this example, special arc discharge), e-f is an initial arc discharge period, f is a moment when the lamp 15 goes out, f-g is a period for which the DC-DC converter 12 outputs open voltage again since the light of the lamp 15 has gone out, g is a reboot time of the ignitor 14, h is a time when dielectric-breakdown of the lamp 15 occurs again, h-i is a glow discharge period, i-j is a shift period from glow discharge to initial arc discharge, j-k is an initial arc discharge period, k-l is an arc growth period, and l and later is a stable rated operation period. Note that in FIGS. 2A through 2D, scales of the horizontal axes are partially emphasized for explanation, and a length of a lateral axis direction in FIGS. 2A through 2D does not show time characteristics concerning actual lighting of the lamp.

First, a switch of not-shown system power of the lighting device 1 is turned on, and the DC-DC converter 12 operates to generate voltage on the capacitor 13 (time a). This voltage is for example 400V. By the voltage, the ignitor 14 is activated, and high voltage is applied to the lamp 15. Period a-b is a period from voltage-output by the DC-DC converter 12 to high voltage-output by the ignitor 14. This period, which depends on the circuitry of the ignitor 14, is about several milliseconds. Period f-g mentioned later is also the same. Period b-c is a period from start-up of an operation of the ignitor 14 to dielectric breakdown of the lamp 15. This period, which depends on a state of the lamp 15, is approximately from tens of milliseconds to hundreds of milliseconds. In this period dielectric breakdown is caused by applied high voltage. At a moment when dielectric breakdown occurs, the voltage shown in FIG. 2A drops, and at the same time, a rush current shown by a dotted line of FIG. 2B is generated. Although when the resistor 16 is not provided, or when a resistance value of the resistor 16 is zero Ω, a rush current (peak) of about 100 A flows for several microseconds, the rush current is absorbed by impedance of the resistor 16 as shown by a solid line of the FIG. 2B.

The glow discharge begins at time c or later, and lamp voltage VL decreases gradually toward time d, for example from 200V to 100V. For period c-d, the lamp current IL has little change, and is 0.5 A, for example. This period, which depends on a state, a type, etc. of the lamp 15, is about tens of milliseconds. Also for this period, the voltage Vr across the resistor 16 and the gate current Ig of the thyristor 17 also increase gradually. At time d, when the lamp voltage VL decreases to about 100V, the lamp 15 shifts from the glow discharge to the arc discharge. At time e, the lamp voltage falls to about 10V rapidly, and the lamp current IL tends to flow infinitely.

Here, the lamp current IL is controlled by an operation of a current limiter of the DC-DC converter 12, and in this example 2 A is considered as an upper limit. Period d-e is a momentary period of 100 microseconds, for example. For period d-e, the gate current Ig of the thyristor 17 rises with the rise of the voltage Vr across the resistor 16. And the breakover of the thyristor 17 occurs at the operating point which is set by the voltage Vak between the anode and the cathode and a gate current Ig of the thyristor 17. Here, the auxiliary resistor 21 is assumed to be 820Ω. At time d, the gate current Ig is 6 mA (=10Ω×0.5 A/820Ω), and at time e the gate current Ig is 24 mA (=10Ω×2 A/820Ω). When the thyristor 17 is a thyristor which has breakover at 20 mA, the breakover occurs when the lamp current is about 1.6 A. That is, in the course of period d-e, the thyristor 17 is turned on by the breakover, and a current begins to flow between the anode and the cathode of the thyristor 17. As mentioned above, the resistor 16 suppresses a rush current and the thyristor 17 is turned on automatically by the lamp current. Therefore, it is not necessary to carry out complicated control from the outside. Although the resistor 16 and the thyristor 17 are inserted on a low potential side (side on which the potential is near a ground) of the lamp 15 in FIG. 1, they may be inserted on a high potential side (side on which the open voltage of 400V of the DC-DC converter 12 is generated and the voltage of 2 kV is generated at an activation of the ignitor 14) of the lamp 15. Although when a circuit needs to be controlled from the outside, selection of a part having high withstand pressure, a level shifter which shifts a control signal to a high-voltage side, etc. are needed, this example enables a floating constitution, since control from the outside is not necessary. In FIG. 1, the lamp 15 is assumed to be of a DC (direct current) drive type. An upper side of the lamp 15 in FIG. 1 is an anode, a lower side thereof is a cathode, and potential of the anode is higher than that of the cathode. When an AC type lamp is assumed, in the latter part of the ignitor 14 an inverter provided with four FETs is inserted. The inverter converts DC voltage into AC voltage by defining two FETs as a pair, and turning on or turning off the pair of FETs alternately. In such a case, electrodes of both ends of the lamp 15 becomes in a floating state with respect to the ground. When a circuit with external control is assumed to be connected, in order to apply a control pulse to a floating position, there is a necessity of using an isolation transformer, or the like, and thus, a size of the circuit tends to increase. On the other hand, in the present embodiment, since control from the outside is unnecessary, it is possible to insert the thyrister etc. in arbitrary places inside an inverter circuit, thereby increasing flexibility of a design.

After the thyristor 17 is turned on, the voltage Vak between the anode and the cathode of the thyristor 17 is 0.8V, for example. As shown in FIGS. 2C and 2D, since a resistance value of internal resistance of the thyristor 17 is small enough as compared with a resistance value 10Ω of the resistor 16, little current flows through the resistor 16, thereby reducing power consumption. For example, the lamp 15 is assumed to carry out an operation of 160 W by 80V, 2 A during a rated lighting time. In a constitution in which the lamp current is not bypassed by the thyristor 17, it always pass through the resistor 16. The power consumption thereof is 40 W (=2 A×2 A×10Ω). Efficiency of a general DC-DC converter 12 is around 80%. For generating 160 W, a loss of the DC-DC converter 12 is 40 W (=160 W/0.8). Therefore, a loss in the resistor 16 is the same amount as the loss of DC-DC converter 12, and is not acceptable. A resistor capable of losing 40 W becomes large-sized. When the lamp current is bypassed by the thyristor 17, the loss thereof is 2 W (=0.8V×2 A), and can be reduced to 1/20. An equivalent resistance value of the thyristor 17 is 0.4Ω (=0.8V/2 A) at this time, and is small enough as compared with the resistor 16 or the auxiliary resistor 21. As mentioned above, after lighting of the lamp shifts to the initial arc discharge, the thyristor 17 is in an on-state during the rated lighting. A rush current is suppressed at the activation time thereby enabling-loss reduction.

For period e-f, the initial arc discharge is maintained, the lamp current is in a controlled state at 2 A by current limiting of the DC-DC converter 12. Usually lamp voltage rises gradually like in a below-mentioned period k-l, the DC-DC converter 12 starts constant power operation, and the lamp current decreases. However, depending on circumstances, discharge may go out at the initial arc discharge time. In FIGS. 2A through 2D, it is assumed that going-out occurs at time f. At time f, since going-out due to generation of a special arc has occurred, the lighting device 1 generates open voltage again (period f-g), and with the voltage the ignitor 14 generates high voltage (period g-h), and the lamp 15 is lighted again at time h. In the series of operations, in a case where the thyristor 17 which is turned on during period d-e, still remains in an on-state, a rush current flows through the lamp 15 through the thyristor 17 of low resistance at a second dielectric breakdown at time h, thereby giving damage to the lamp 15. However, since a current which flows between the anode and the cathode of the thyristor 17 becomes zero at a time when the lamp current becomes zero at time f, the thyristor 17 becomes in an off-state. Therefore, since the thyristor 17 is in an off-state at time h, like time c, a rush current flows through the resistor 16, and as shown in FIG. 2B, the current shown by a dotted line is suppressed as shown by a solid line. That is, in the present embodiment, it is possible to control the thyristor 17 optimally and self-containedly also at a second or later re-lighting of the lamp due to the going-out. Then, like the above-mentioned, period h-i is a glow discharge period similarly to period c-d, the thyristor 17 is in an off-state, and a current flows through the resistor 16. Period i-j is a shift period from glow discharge to arc discharge, like period d-e. During period i-j, for example, at a time when the lamp current is 1.6 A in the course of changing from 0.5 A to 2 A, the voltage Vak of 16V (=10Ω×1.6 A) is applied between the anode and the cathode, and the gate current Ig is 20 mA, on these conditions the breakover of the thyristor 17 occurs. Thereafter, if going-out does not occur, the lamp 15 warms up gradually during period j-k, the lamp voltage rises during period k-l, the constant power operation begins, and the rated lighting operation begins after time l.

For example, when a gate current Ig required for the breakover of the thyristor 17 is 40 mA, a resistance value of the auxiliary resistor 21 may be set to 390Ω (40 mA =10Ω×1.6 A/390Ω). That is, a timing of the breakover can be adjusted by a resistance value of the auxiliary resistor 21, and parameters are not linked to each other complicatedly. In the above-mentioned operations, a lamp current flows through the resistor 16 during glow discharge (period c-d and period h-i). The loss is 5 W in a case of 10Ω and 0.5 A. Since this period is tens of milliseconds, a resistance may be selected which has a rating capable of losing 5 W in an instant.

Moreover, although in the above-mentioned constitution, a timing when the thyristor 17 is turned on during period d-e is explained, the thyristor 17 may be designed so as to turn on during period c-d. For example, it is assumed, as the conditions for causing the thyristor 17 to shift from off to on, when the lamp current during the glow discharge time is 0.5 A, that the voltage Vak between the anode and the cathode is 15 V, and the gate current Ig is 20 mA. A resistance value of the resistor 16 is selected to 30Ω. At time c, while a rush current is suppressed by the resistor 16, a voltage drop of 15V (=0.5 A×30Ω) occurs across the resistor 16 with a glow current of 0.5 A. When a resistance value of the auxiliary resistor 21 is selected at 750Ω, the gate current Ig flows by 20 mA (=15V/750Ω) with this voltage. Therefore, the voltage Vak between the anode and the cathode becomes 15V, the gate current Ig becomes 20 mA, and the thyristor 17 is turned on during period c-d. A loss in a case of a current of 0.5 A flowing through the resistor 16 is 7.5 W (=0.5 A×0.5 A×30Ω). As mentioned above, a constitution may be designed in which the thyristor 17 is turned on during the glow discharge. When a current of 2 A of initial arc discharge flows through the resistor 16, a loss of the resistor 16 increases, thereby increasing a size of the resistor 16 considering a permissible loss. In order to avoid such a situation, the resistance values of the resistor 16 and the auxiliary resistor 21 may be selected so that the thyristor 17 is turned on during period c-e. Moreover, since the resistor 16 and the auxiliary resistor 21 do not act on temporary going-out of light during the lighting time, a constitution may be designed so as to turn on the thyristor 17. A main purpose of the protective resistor 22 is protection against overvoltage of the gate of thyristor 17, and the protective resistor 22 does not act on the operations of the present embodiment. Therefore, according to the specifications of the thyristor 17, a resistance value of the protective resistor 22 may be set to 1 kΩ to 10 kΩ, for example. When protection for the gate is not required, the protective resistor 22 may be omitted.

After time j, the voltage Vak between the anode and the cathode of the thyristor 17 is 0.8V, for example. When a current of 2 A flows, internal equivalent resistance between the anode and the cathode of the thyristor 17 in an on-state is 0.4Ω (=0.8V/2 A). As shown in FIGS. 2C and 2D, since the resistance value of the internal resistance of thyristor 17 is small enough as compared with the resistance value of 10Ω of the resistor 16, a current hardly flows through the resistor 16, thereby reducing power consumption. On/off control of the thyristor 17 does not need control from the outside. For example, a constitution can be devised easily in which a rush current is reduced or bypassed by detecting a lamp current and carrying out switching operation of a FET. However, a rush current is generated and converges for six microseconds. When the rush current is controlled by detecting this pulse form current and transmitting existence of generation to a control system, at least 3 microseconds, which is a half of 6 microseconds, is required, in terms of a response speed of the system. Since a speed of 10 times the speed of a uncontrolled object is required in order to obtain a sufficient response characteristic, a response time thereof is 600 nanoseconds, and when the response time is represented by a clock frequency, the response time is a frequency of 1 MHz or more. It is not realistic to detect a rush current and control it by a control system with such a response speed. On the other hand, in this embodiment, since the on/off operation is carried out self-containedly, the above-mentioned response speed of a mega-Hz order is obtained equivalently, thereby operating ideally with a small number of the parts. In the present embodiment, a direct-current drive type lamp 15 is explained as an example. However, the lamp is not restricted to this, and an alternating current drive type lamp may be used which is driven by periodical alternation of the polarities of voltage across the lamp 15. When the lamp 15 is to be lighted, an inverter circuit (not shown) is added between the capacitor 13 and the lamp 15, and converts a direct current into an alternating current. In such a constitution, the above-mentioned resistor 16 and the thyristor 17, or the like are inserted into a portion between the capacitor 13 and the inverter circuit in which a current flows only in one way. Also in this case, an effect of suppressing a rush current is obtained.

### Embodiment 2

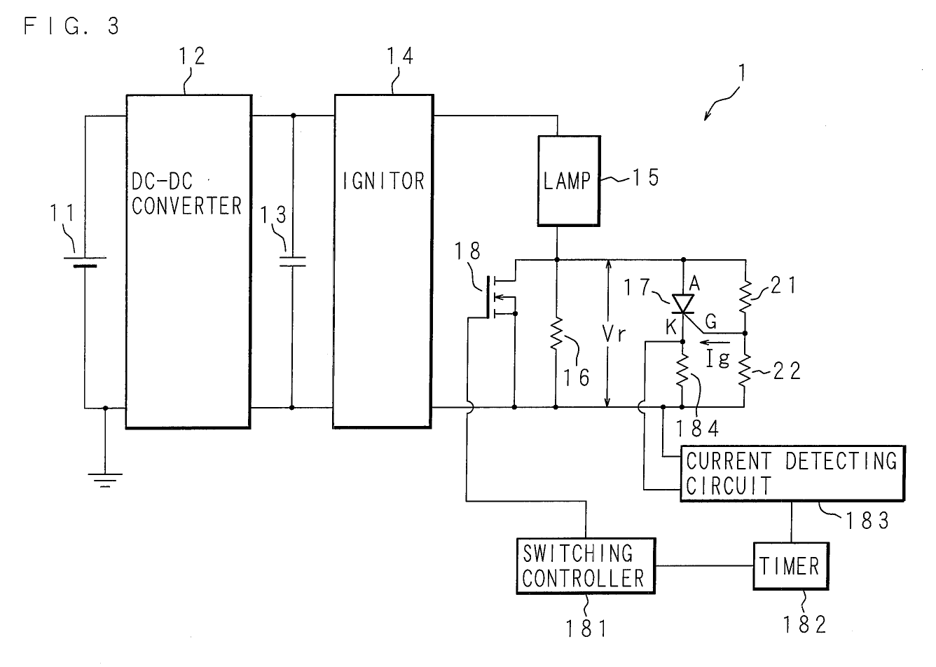

Embodiment 2 relates to an embodiment in which reduces more power consumption by additionally connecting a switching element in parallel and turning on the switching element after elapse of a predetermined time. FIG. 3 is a circuit diagram showing the circuitry of a lighting device 1 according to Embodiment 2. In addition to the constitution of Embodiment 1, the lighting device 1 is constructed including a switching element 18, a switching controller 181, a timer 182, a current detecting circuit 183, and a current detecting resistor 184. As the switching element 18, for example, a FET (hereinafter, FET 18) is used. The FET 18 is connected in parallel with the resistor 16, the thyristor 17, and the auxiliary resistor 21 and the protective resistor 22.

The FET 18 has a drain connected to the lamp 15, a source connected between the ignitor 14 and resistor 16, and a gate connected to the switching controller 181. The switching controller 181 alternatively outputs to the FET 18 a low signal of 0V or a high signal of 5V, for example. When a low signal is outputted, the FET 18 is turned off, and when a high signal is outputted, the FET 18 is turned on. The current detecting circuit 183 is a circuit which detects a lamp current, and outputs a detected current signal to the timer 182. Note that although the present embodiment is an embodiment in which a current which flows through the thyristor 17 is detected by the current detecting circuit 183 and current detecting resistor 184, the constitution is not restricted to this, and a signal related to voltage applied to the thyristor 17, voltage applied to the resistor 16, or a current which flows through the resistor 16 may be outputted to the timer 182. Detection results of the voltage and current of the respective parts may not be linked with the timer 182, and the detection results may be linked with a switch of system power. The DC-DC converter 12 contains a circuit which detects a lamp current in order to control power to be supplied to the lamp 15. The current detecting circuit 183 shown in

FIG. 3 may be shared with the lamp current detection circuit contained in the DC-DC converter 12.

The timer 182 stores a threshold value in an internal memory (not shown), and starts clocking when a signal related to a current outputted from the current detecting circuit 183 is smaller than the threshold value. In the examples of FIGS. 2A through 2D, the threshold value is 5 A exceeding a current (for example, 2 A) which flows after breakover of the thyristor 17. The timer 182 outputs a control signal to the switching controller 181 after elapse of a predetermined period of time (for example, 20 seconds) base on clocking. The switching controller 181 outputs a high signal to the FET 18 in response to the control signal from the timer 182. The FET 18 is turned on by the output of the high signal. 20 seconds clocked by the timer 182 is a period which is expected to be long enough to activate the lamp 15 successfully. That is, the lamp 15 at the activation time including going-out etc. is in one of the states of light-out, glow discharge, initial arc discharge, and rated arc discharge. At such indefinite operation time, a loss is reduced by turning off the FET 18, suppressing and absorbing a rush current with the resistor 16, and carrying out on/off control of the thyristor 17 self-containedly. A loss of the device at the rated operation time is reduced since a resistance component inserted in the lamp 15 in series is decreased by turning on the FET 18 after elapse of a period expected to be long enough to carry out the rated operation.

A resistance value of an internal resistance of the FET 18 is about 0.2Ω, and is smaller than a resistance value of 0.8Ω of internal resistance of the thyristor 17. In this case, a current which has flowed through the thyristor 17 flows through the FET 18 mostly, and the thyristor 17 is turned off, thereby decreasing power consumption to 0.2 W when a lamp current IL of 1 A flows. Moreover, the voltage Vr across the resistor 16 changes from 0.8V to 0.2V by turning on the FET 18. When a not-shown system power of the lighting device 1 is turned off, clocking of the timer 182 is reset to 0, a signal outputted from the switching controller 181 is also reset to a low signal, and the FET 18 is turned off. Note that in the present embodiment, although the FET 18 is turned on after elapse of a predetermined time after breakover of the thyristor 17, the FET 18 may be turned on after the lamp 15 starts a stable rated operation and then a sufficient time has passed. In this case, the FET 18 is turned on after turning on the not-shown system power, for example, after 30 seconds. A resistance value of the current detecting resistor 184 is for example 50 milliΩ, and does not affect the on/off operation of the thyristor 17.

Embodiment 2 is constituted like the above, since other constitutions and operations are the same as those of Embodiment 1, the same reference numbers are given to the corresponding portions, and the detailed explanation is omitted.

### Embodiment 3

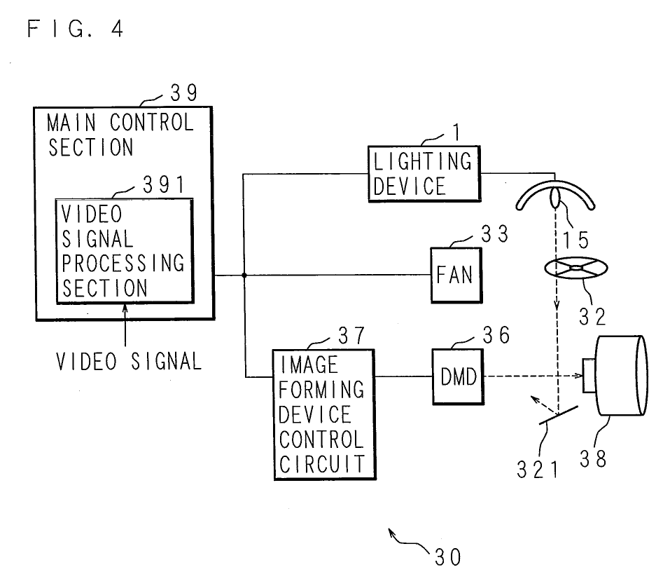

The above mentioned lighting device 1 is applied to a projector. FIG. 4 is a block diagram showing a hardware configuration of the projector. The projector 30 is constituted including the lighting device 1 of Embodiment 1 or 2, the lamp 15, a reflecting mirror 321, a color wheel 32, an image forming device (hereinafter DMD (Digital Micromirror Device (registered trademark)) 36, an image forming device control circuit 37, a projector lens 38, a fan 33, a main control section 39, and a video signal processing section 391.

The main control section 39 controls the above mentioned respective parts of hardware according to a program stored in a not-shown memory. A video signal is inputted to the video signal processing section 391. The video signal processing section 391 performs processing on the video signal, such as synchronizing separation and scaling, etc. and outputs a processed video signal to the image forming device control circuit 37. In the projector 30, white light emitted from the lamp 15 is condensed, and is emitted to the color wheel 32. The color wheel 32 is constituted as a disk on which a red light filter, a blue light filter and a green light filter are arranged in a circumferential direction thereof, and is rotated at a high speed by a not-shown drive motor.

The color filters are inserted one by one in an optical path of light emitted from the lamp 15 with rotation of the color wheel 32, and the white light irradiating the color wheel 32 is separated to each homogeneous light of red light, green light and blue light by time sharing. And each separated homogeneous light is sent to the reflecting mirror 321, and irradiates the DMD 36. Note that instead of the DMD, a liquid crystal panel may be used. Drive of the DMD 36 is controlled by the image forming device control circuit 37. The image forming device control circuit 37 drives the DMD 36 according to the inputted video signal. Specifically, by turning on or turning off each cell and minute mirror of the DMD 36 according to the inputted video signal, the irradiating homogeneous light is reflected pixel by pixel, and is light-modulated, thereby forming an image light. The formed image light is incident on the projector lens 38, and is enlarged and projected to a not-shown screen etc. by the projector lens 38.

The lighting device 1 controls turning on and off of the lamp 15. The fan 33 is a component for cooling the inside of the lamp 15 or the projector 30, and driven by a not-shown motor. Note that although in the present embodiment the configuration is explained in which the lighting device 1 is applied to the projector 30, the configuration is not restricted to this, and may be applied to general illumination, a head lamp of a car, etc.

Embodiment 3 is constituted like the above, and since other constitutions and operations are the same as those of Embodiments 1 and 2, the same reference numbers are given to the corresponding portions, and the detailed explanation is omitted.

### Embodiment 4

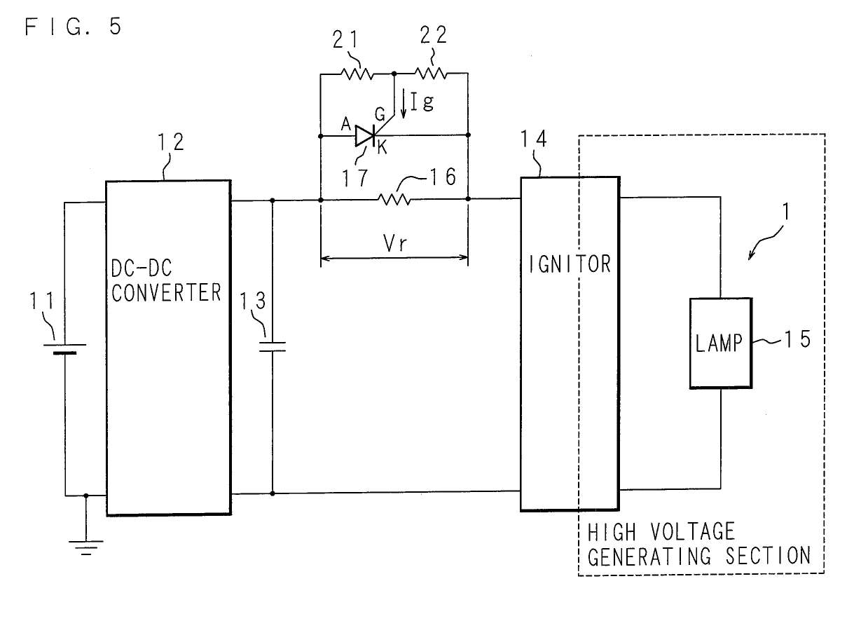

FIG. 5 is a circuit diagram showing circuitry of the discharge lamp lighting device according to Embodiment 4. In Embodiment 4, the circuit which is constituted by the resistor 16, thyristor 17, auxiliary resistor 21, and protective resistor 22 as described in Embodiment 1 may be provided between the DC-DC converter 12 or capacitor 13 and the ignitor 14. Details are explained below. The capacitor 13 is connected in parallel with the latter part of the DC-DC converter 12. Between the DC-DC converter 12 or capacitor 13 and the ignitor 14, the circuit is provided which is constituted by the resistor 16, thyristor 17, auxiliary resistor 21, and protective resistor 22 as described in Embodiment 1. The resistor 16 is connected in series with an anode electrode side of the lamp 15 via an input of the ignitor 14. Moreover, the thyristor 17, and the auxiliary resistor 21 and protective resistor 22 are connected in parallel with the resistor 16. The auxiliary resistor 21 and protective resistor 22 are connected in series, the auxiliary resistor 21 has one end connected to a gate of the thyristor 17 and the other end thereof is connected to an anode of the thyristor 17. The protective resistor 22 has one end connected to the gate of thyristor 17 and the other end thereof is connected to a cathode of the thyristor 17. Note that a part enclosed by a dotted line is a high voltage generating section. In a conventional method in which a switch is controlled from the outside, when a high side switch constitution (method in which a switching circuit is inserted in a high potential line) is adopted, an additional circuit is required for converting a voltage level of a switching pulse to high voltage. That is, a switching circuit is conventionally based on a ground potential. In the present embodiment, the switching circuit is closed self containedly, and it is not required to be based on the ground potential. For example, since high voltage of several kV is generated on an output side of the ignitor 14 even for an instant, securement of air clearance between parts and concern for safety are required. Therefore, it is disadvantageous in terms of a layout of the lighting device 1 or the projector 30 to newly add parts on the output side of the ignitor 14. Since the ignitor 14 is required to be separated from the DC-DC converter 12, and to be arranged near the lamp 15, it is difficult to design a layout of the resistor 16 or the thyristor 17, or the like. In the present embodiment, by arranging the thyristor 17 etc. at a position shown in FIG. 5, an effect enabling improvement in flexibility of the layout and a miniaturization design of the projector is obtained.

Embodiment 4 is constituted like the above, and since other constitutions and operations are the same as those of Embodiments 1 and 3, the same reference numbers are given to the corresponding portions, and the detailed explanation thereof is omitted.

1-8. (canceled)

9. A discharge lamp lighting device which lights a discharge lamp, comprising:
a resistor connected in series with said discharge lamp;
a silicon controlled rectifier connected in parallel with said resistor; and
an auxiliary resistor connected between an anode and a gate of said silicon controlled rectifier.

10. The discharge lamp lighting device according to claim 9, wherein
said auxiliary resistor controls said silicon controlled rectifier from off to on, by passing a gate current through said silicon controlled rectifier with the use of voltage generated across said resistor as a power source.

11. The discharge lamp lighting device according to claim 9, wherein said silicon controlled rectifier in an on-state shifts from on to off according to a state of a current which flows through said discharge lamp.

12. The discharge lamp lighting device according to claim 9, wherein said resistor, said silicon controlled rectifier and said auxiliary resistor are in floating states with respect to a ground.

13. The discharge lamp lighting device according to claim 9, further comprising:
a switching element connected in parallel with said resistor, said silicon controlled rectifier, and said auxiliary resistor; and
a switching controller which switches said switching element from off to on after breakover of said silicon controlled rectifier.

14. The discharge lamp lighting device according to claim 13, wherein a resistance value of on-resistance of said switching element in an on-state is smaller than a resistance value of internal equivalent resistance between the anode and a cathode of said silicon controlled rectifier in an on-state.

15. The discharge lamp lighting device according to claim 9, wherein a resistance value of internal equivalent resistance between the anode and the cathode of said silicon controlled rectifier in an on-state is smaller than a resistance value of said resistor.

16. A projector, comprising:
said discharge lamp lighting device defined in claim 9.
